(19) United States
(12) Patent Application Publication
(10) Pub. No.: US 2026/0301546 A1
(43) Pub. Date: Oct. 1, 2026

(54) ARTIFICIAL INTELLIGENCE-BASED AUTOMATED STEUP AND CONFIGURATION OF RETAIL POINT OF SALE SYSTEM

(71) Applicant: TOSHIBA GLOBAL COMMERCE SOLUTIONS, INC., Durham, NC (US)

(72) Inventors: Jonathan Myles WAITE, Durham, NC (US); Jessica K. SNEAD, Durham, NC (US); Lucas BLANCK, Durham, NC (US); Shyam VENKATARAMAN, Durham, NC (US)

(73) Assignee: TOSHIBA GLOBAL COMMERCE SOLUTIONS, INC., Durham, NC (US)

(21) Appl. No.: 19/095,495

(22) Filed: Mar. 31, 2025

(51) Int. Cl. G07G 1/00; G06Q 20/20

(52) U.S. Cl. CPC G07G 1/0009; G06Q 20/206

(57) ABSTRACT

The present disclosure provides an AI-based personal took for configuring Point of Sale (POS) systems. The AI-based configuration tool allows users to interact with a conversational AI that guides them through various configuration steps, eliminating the need for navigating through cumbersome menus and settings. The AI can also provide visual feedback and drive the UI configuration based on user inputs, ensuring a seamless and intuitive setup process.

### BACKGROUND

In the retail industry, configuration setup and management of a point-of-sale device system (“POS”) is complex, and there is difficulty in understanding the impact of all the user configurations. Additionally, customer business rules add to this complexity.

### BRIEF DESCRIPTION OF THE DRAWINGS

The objects and features of the present disclosure can be better understood with reference to the drawings described below, and the claims. The drawings are not necessarily to scale, emphasis instead generally being placed upon illustrating the principles of embodiments of the present disclosure. In the drawings, like numerals are used to indicate like parts throughout the various views.

FIG. 1 depicts an example high-level architecture in accordance with implementations of the present disclosure.

FIG. 2 depicts an example architecture in accordance with implementations of the present disclosure.

FIG. 3 depicts an example of a layered architecture and environment of an enterprise generative artificial intelligence system in accordance with implementations of the present disclosure.

FIG. 4 depicts an example process that can be executed in accordance with implementations of the present disclosure.

FIG. 5 depicts another example process that can be executed in accordance with implementations of the present disclosure.

### DETAILED DESCRIPTION OF THE EMBODIMENTS

### General Summary Description

Generally, the present disclosure provides an AI-based tool to be used by a point of sale device (“POS”). Rather than navigating through various configurations, each POS is to be configured through a prompt-based, chat interface which will navigate and configure the system for the POS user based upon user prompting. The resulting actions may drive the UI configuration interface or visualize the configuration back to the user in a chat session. The AI-based POS system configuration tool can also be used to augment various configuration sections of the POS back office applications with pointed prompt entries.

The proposed POS system configuration tool leverages a chat-based interface to simplify the often complex process of setting up and managing a POS system. This tool allows users to interact with a conversational AI that guides them through various configuration steps, eliminating the need for navigating through cumbersome menus and settings. The AI can also provide visual feedback and drive the UI configuration based on user inputs, ensuring a seamless and intuitive setup process.

Below is a brief overview of how this could work, according to some general embodiments.

1- User Interaction via Chat Interface and enrichment prompts.

Users interact with the POS system configuration tool through a chat interface. This interface can be accessed via a web application, mobile app, or directly within the POS system. The chat interface uses natural language processing to understand and respond to user prompts.

2- AI-Powered Guidance:

The AI engine is integrated with the chat interface to provide real-time guidance and responses. When a user asks a question or requests a specific configuration, the AI tool interprets the query and provides step-by-step instructions or directly configures the system as needed and then presents an output.

3- Configuration Actions:

The AI tool can perform configuration actions such as setting up payment methods, adding new products, configuring tax rates, business rules, receipt configuration, and managing user roles. Users can also request visual feedback, wherein the AI-driven system can generate a UI preview of the configuration changes.

4- Visualization and Feedback:

The system can visualize the configuration settings back to the user within the chat interface. For example, if a user configures a new product, the chat interface can display the product details for confirmation.

The AI can also provide recommendations based on best practices or common configurations.

5- Implementation

Architecture Overview: Frontend: The chat interface, serves as the primary user interaction point. Backend: A backend system handles chat interactions, integrates with the AI engine, and performs configuration actions.

The AI Engine may be an AI engine powered by models or custom-trained NLP models that understand user prompts and generate appropriate responses and actions.

Database: A database (e.g., MongoDB) that stores configuration settings, user data, and interaction logs. The backend will provide the AI engine with appropriate context, and example to drive the AI engine. A prompt flow may be used to guide the result to a workable outcome.

Security and Permissions:

User authentication and authorization to ensure only authorized personnel can perform certain configurations. Logging and monitoring of all configuration actions for audit purposes.

6- Problem Solved

The proposed solution addresses the problem of complex and time-consuming POS system configuration by: providing an intuitive, chat-based interface that simplifies the configuration process; utilizing AI to guide users through setup steps and perform configurations based on natural language prompts; offering real-time visualization and feedback to ensure users understand the changes being made; reducing the need for extensive training and manual navigation through traditional configuration menus. This approach not only enhances user experience but also increases efficiency and accuracy in configuring POS systems.

### DETAILED DESCRIPTION OF SOME EMBODIMENTS

Various examples and more details of the present disclosure will now be described below. The following description provides specific details for a thorough understanding and enabling description of these examples. One skilled in the art will understand, however, that the present disclosure may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the present disclosure. Certain terms may even be emphasized below; however, any terminology intended to be interpreted in any restricted manner will be overtly and specifically defined as such in this Detailed Description section.

With reference now to the figures, the present disclosure provides a novel intelligence system for various applications, such as retail applications. The intelligence system employs a large language model (LLM) and generative AI, technologies capable of understanding and responding to human language in a meaningful and contextual manner in order to be an automated way for employees of the company to set up and configure POS systems in some embodiments.

In this regard, implementations of the present disclosure are generally directed to a computer-implemented platform for an artificial intelligence (AI)-based digital POS setup/configuration agent (also referred to herein as AI framework and/or AI assistant). Implementations of the present disclosure may be directed to a hybrid platform that provides on-premise components, and/or leverages cloud-hosted components. In general, and as described in further detail herein, the AI framework of the present disclosure eases the burden of enterprise tasks, enables interactions through multiple channels, and leverages cloud-hosted components to perform services, while maintaining security and confidentiality of information (e.g., customer and/or company sensitive information (SI)). It can assist employees in configuring/setting up POS systems, managing inventory, making data-driven decisions, and any other tasks relating to managing POS systems.

As described in further detail herein, implementations of the present disclosure include actions of receiving communication data from a device, the communication data including data input by a user of the device, determining a context based on an extended finite state machine that defines contexts and transitions between contexts, transmitting a service request to at least one cloud-hosted service, the service request being provided at least partially based on masking sensitive information included in the communication data, receiving a service response from the at least one cloud-hosted service, the service response including one or more of an intent, and an entity, determining at least one action that is to be performed by at least one back-end source system based on the service response, providing a response at least partially based on an action results received from the at least one back-end source system, and transmitting the result data to the device.

The present disclosure of AI-based system represents a significant advancement in retail technology, providing retail workers with an easy-to-use tool to perform various and complicated tasks for a POS system. The use of advanced AI technologies allows for a more contextually aware and user-friendly system, resulting in improved efficiency and effectiveness for retail workers.

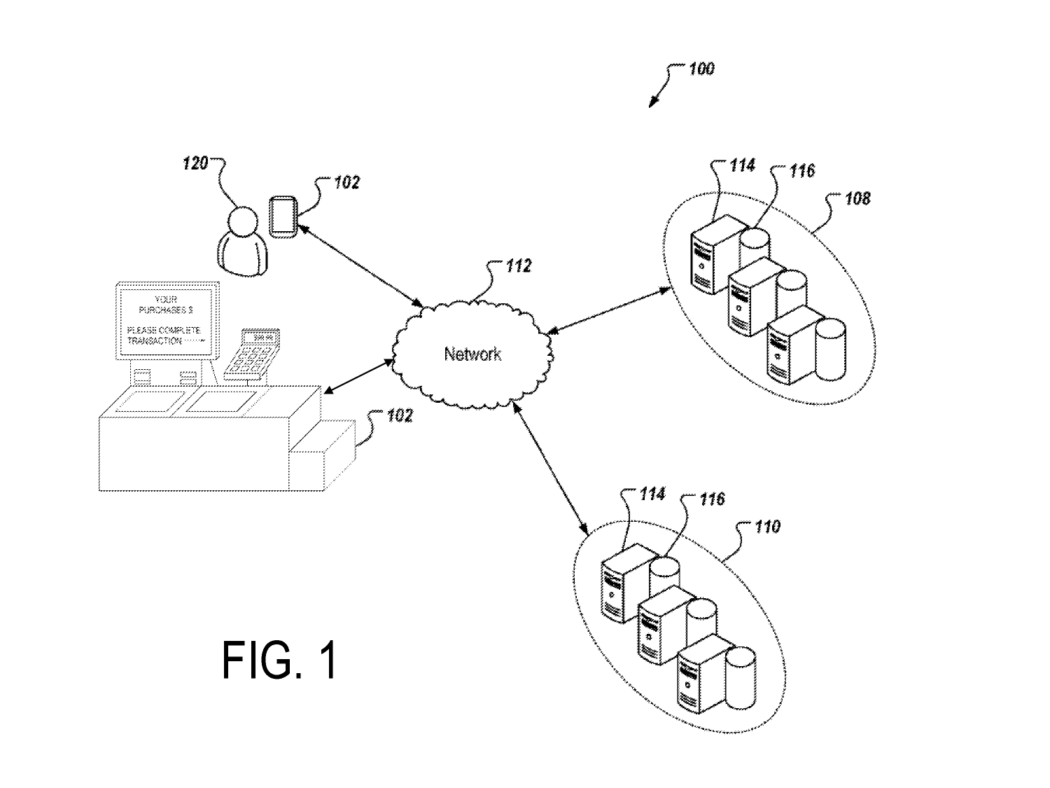

FIG. 1 depicts an example high-level architecture 100 in accordance with implementations of the present disclosure. The example architecture 100 includes a POS device 102 (and/or mobile device), back-end systems 108, 110, and a network 112. In some examples, the network 112 includes a local area network (LAN), wide area network (WAN), the Internet, a cellular telephone network, a public switched telephone network (PSTN), a private branch exchange (PBX), or any appropriate combination thereof, and connects web sites, devices (e.g., the POS device 102), and back-end systems (e.g., the back-end systems 108, 110). In some examples, the network 112 can be accessed over a wired and/or a wireless communications link.

In the depicted example, each of the back-end systems 108, 110 includes at least one server system 114, and data store 116 (e.g., database). In some examples, one or more of the back-end systems hosts one or more computer-implemented services that users can interact with using devices. For example, and as described in further detail herein, the back-end systems 108, 110 can host the AI framework in accordance with implementations of the present disclosure. The backend system handles chat interactions, integrates with the AI engine, and performs the configuration actions directly to the POS (where the chat sessions may be).

The backend will provide the AI engine with the appropriate context and examples to drive the AI engine, which may be obtained using private databases/models of the company, open source models, public AI models, or any other AI models or databases to train the POS training AI model herein.

In some examples, the POS device 102 is a point-of-sale device, such as a self-checkout system that is configured to identify products that are being presented for purchase by a customer. The POS device 102 has imaging technology to scan a product code or the product itself and communicates with databases and backend systems to determine prices of the product as well as payment systems.

It should be noted that the POS device 102 can each include any appropriate type of computing device such as a desktop computing system, a laptop computing system, a handheld computer, a tablet computer, a personal digital assistant (PDA), a cellular telephone, a network appliance, a camera, a smartphone, a telephone, a mobile phone, a media player, a navigation device, an email device, a game console, or an appropriate combination of any two or more of these devices, or other data processing devices.

In the depicted example, the POS device 102 is used by a user 120. In accordance with the present disclosure, the user 120 uses the POS device 102 to interact with the AI framework of the present disclosure. In some examples, the user 120 can include a customer of an enterprise that provides the AI framework. For example, the user 120 can include a customer that communicates with the enterprise through one or more channels using the device 102. In accordance with implementations of the present disclosure, and as described in further detail herein, the user 120 can provide verbal input (e.g., speech), textual input, and/or visual input (e.g., images, video) to the platform, which can process the input to perform one or more actions, and/or provide one or more responses.

Implementations of the present disclosure are described in further detail herein with reference to exemplary contexts. One example context includes a retail store (e.g., grocery store) as an enterprise that implements the AI framework of the present disclosure. In the first example context an employee (e.g., a cashier) can interact with the hybrid AI framework to perform tasks related to configuration of the POS (e.g., training of the POS, setup up of the POS, setting up/maintaining inventory, etc.). It is contemplated, however, that implementations of the present disclosure can be realized in any appropriate context.

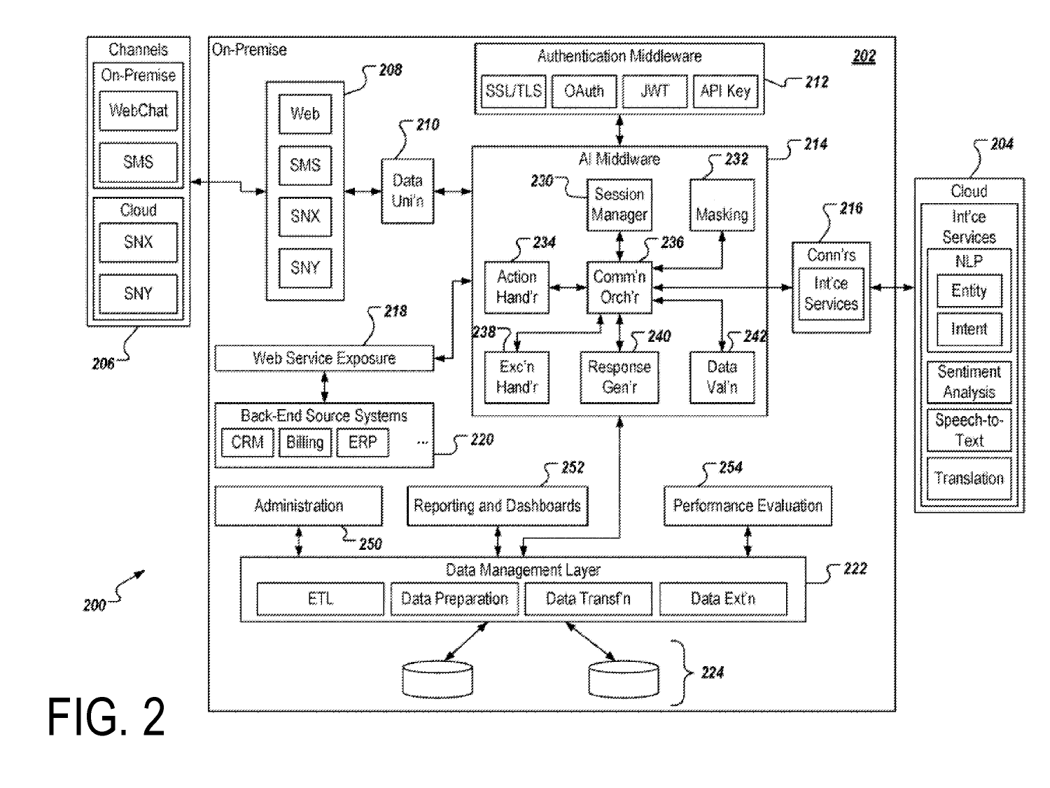

FIG. 2 depicts an example architecture 200 of a AI framework in accordance with implementations of the present disclosure. In some examples, components of the example architecture 200 can be hosted on one or more back-end systems (e.g., the backend systems 108, 110 of FIG. 1). In some examples, each component of the example architecture 200 is provided as one or more computer-executable programs executed by one or more computing devices.

In the depicted example, the example architecture 200 includes an on-premise portion 202, and a cloud portion 204 (e.g., of an AI assistant of the present disclosure). In some examples, the on-premise portion 202 is hosted on a back-end system of an enterprise providing the AI framework (e.g., a retail store). That is, within an intranet of the enterprise, for example. For example, the on-premise portion 202 can be hosted on the back-end system 108 of FIG. 1. In some examples, the cloud portion 204 is hosted on one or more back-end systems of respective cloud-based service providers. For example, at least a portion of the cloud portion 204 can be hosted on the back-end system 110 of FIG. 1.

In the depicted example, the example architecture 200 includes channels 204, through which a user (e.g., a retail store employee) can communicate with the on-premise portion 202. Example channels include voice, chat, text, and the like. For example, the user can use a device (e.g., the POS device 102 of FIG. 1) to provide speech to text to the on-premise portion 204 (e.g., over the network 112 of FIG. 1).

As another example, the user can provide input through one or more secure networks (e.g., a first secure network (SNX), a second secure network (SNY)) to the on-premise portion 204 (e.g., over the network 112 of FIG. 1). As another example, the user can provide input through a messaging application (e.g., chat) associated with the POS device 102. Various methods may be employed but the primary method used as an example herein is the user talking to the POS device 102 and the POS device 102 using large language models (LLM) to process the user’s speech input. In this regard, the users of the POS device 102 interact with the POS system configuration tool through a chat interface presented to the user on the POS device 102. It should be noted, though, that this interface can be accessed via a web application, mobile app, or directly within the POS system. The chat interface uses natural language processing to understand and respond to user prompts.

It should be understood that the various channels 206 could be on-premise 202 or off premise (as shown in FIG. 2). In this regard, the present disclosure is not limited to an employee or company representative to be on-premise of the retail enterprise to perform the systems herein.

In some implementations, the on-premise portion 202 includes channel connectors 208, a data unification layer 210, authentication middleware 212, artificial intelligence (AI) middleware 214, connectors 216, a web service exposure 218, back-end source systems 220, a data management layer 222, and one or more databases 224. In general, and as described in further detail herein, user communications are received through one or more of the connectors 208 and are provided to the AI middleware 214 through the data unification layer 210. A user providing a communication (e.g., request, message, etc.) is authenticated by the authentication middleware 212 to ensure that the user is an employee or company representative. In this regard, the authentication middleware 212 will compare an employee number associated with the user with those in a database having prestored employee numbers and corresponding passwords. The authentication middleware 212 will then determine if the password provided by the user matches the password in the database. It should be understood that other methods of authentication are also contemplated as well and the present application should not be limited to the above-described method of authentication.

Next, if the user is authenticated by the authentication middleware 212, a session is established between the device the user is using (e.g., the device 102 of FIG. 1), and the AI middleware 214. Authentication can be executed in any appropriate manner (e.g., credentials (username/password), tokens), as explained above. During the session, the AI middleware 214 can leverage cloud-hosted intelligence services provided by the cloud portion 204 through the connectors 216.

In some examples, the data unification layer 210, included in the on-premise portion 202, converts a format of an incoming message into a standard format that can be processed by components of the on-premise portion 202. For example, the message can be received in a channel-specific format (e.g., if received through WebChat or chatbot, a first format; if received through a secure network, a second format), and the data unification layer 210 converts the message to the standard format (e.g., text). In some examples, the data unification layer 210 converts an outgoing message from the standard format to a channel-specific format. In some examples, the channel connectors 208 abstract details of integrating with the various channels 206 of user communication from the remainder of the on-premise portion 202. This includes communication details as well as the abstraction of data representations. In some examples, the connectors 216 abstract the details of integrating with the cloud-hosted services from the remainder of the AI assistant. This includes communication details, and data representations.

In some implementations, the AI middleware 214 includes a session manager 230, a sensitive information masking component 232, an action handler 234, a communications orchestrator 236, an exception handler 238, a response generator 240, and one or more data validation modules 242. Each of these components are discussed below.

First. the session manager 230 maintains the state, and context of the interactions between the user, and the AI engine. In some examples, a new session is instantiated each time a user initiates communication with the AI engine, and the context is maintained throughout based on mapped intents, described in further detail herein. In this manner, the AI engine is able to provide context-relevant response. Indeed, the AI engine is integrated with the chat interface to provide real-time guidance and responses. To do this, when a user asks a question or requests a specific configuration to the POS device 102, the AI tool interprets the query and provides step-by-step instructions or directly configures the POS device 102 as needed and then presents an output. The AI tool can perform various configuration actions such as setting up payment methods, adding new products, configuring tax rates, business rules, receipt configuration, and managing user roles. The AI engine can also provide recommendations based on best practices or common configurations.

Next, in some examples, the sensitive information masking component 232 masks data that is determined to be sensitive information, such as payment information. In this manner, sensitive information is not exposed over the public Internet or the like. In some examples, masking includes removing data (sensitive information) from a data set that is to be communicated over the network. In some examples, the occurrence of sensitive information can be determined based on rules, and/or regular expressions (regex). In some examples, masking can include character substitution, word substitution, shuffling, number/date variance, encryption, truncation, character masking, and/or partial masking.

It can be determined that information from a cloud-hosted service is required (e.g., an intent/entity of a message received from the user needs to be determined). Consequently, a message including a data set to-be-processed by the cloud-hosted service can be constructed. Any entity within the data set that is determined to be sensitive information can be removed from the data set. For example, an entity that includes sensitive information is not needed to receive an accurate response from one or more of the cloud-hosted services (e.g., the user's account number is not needed for the cloud-hosted service to determine an intent of the message).

In some examples, the action handler 234 coordinates the execution of one or more actions. For example, the action handler 234 sends a request to one or more of the back-end source systems to fulfill an action. Example actions can include, without limitation, retrieving stored information, recording information, executing calculations, and the like. The action handler 234 can also perform any of the configuration actions such as setting up payment methods, adding new products, configuring tax rates, business rules, receipt configuration, and managing user roles. For example, it can be determined that an action that is to be performed includes configuring pricing of inventory for a grocery store (e.g., as described in further detail herein), and to execute this action relating to grocery store inventory, the action handler 234 can transmit a request that includes the item number of interest and other information (e.g. Brand X potato chips, $12.99, snacks). Then the action handler 234 can transmit the request to a back-end source system (e.g., a system that manages the inventory database), and can receive a response from the back-end source system, which includes the result of the action (e.g., a string value indicating the item and associated details has been added to the current inventory database). The action handler 234 can communicate with the communication orchestrator 236 to communicate with the appropriate database or AI training models in order to complete the above actions. As noted above, the AI Engine may be an AI engine powered by models or custom-trained NLP models that understand user prompts and generate appropriate responses and actions and thus, the action handler 234 and communication orchestrator 236 facilitate the connection between POS-specific databases and AI models to complete the specific tasks directly associated with the POS device 102.

In some examples, the communication orchestrator 236 orchestrates communication between components both internal to the AI middleware 214, and external to the AI middleware 214. For example, the communication orchestrator 236 receives communications from the data unification layer 210 (e.g., requests provided from the user device), and provides communications to the data unification layer 210 (e.g., response to the user device). As another example, the communication orchestrator 236 communicates with the data management layer 222 to access the databases 224, such as databases to establish payment methods (potentially external databases or systems associated with banking entities, entities trained for payment processing, and the like), new product databases that are managed by the company so that when a new product entry is added, the POS can automatically configure itself with the newly-added product, tax rate databases (in order for the POS to be able to configure sales tax rates for shoppers), business rules databases (so the business can add or change business rules), a database defining user roles in the company/store/etc., and the like.

As another example, the communication orchestrator 236 communicates with the cloud-hosted services through the connectors 216 (e.g., sends requests to, receives responses from). In some examples, when a message is received, the communications orchestrator 236 initially provides message information to one or more data validation modules 242 to determine whether data provided in the message is in an expected format, as described herein.

In some examples, the exception handler 238 processes any exceptions (e.g., errors) that may occur during the data. Example exceptions can include, without limitation, cloud-hosted services are not accessible, back-end system is not responding, runtime exceptions (such as null pointer exception). In some examples, the response generator 240 constructs response messages to transmit back to the user. In some examples, the response message can include a result of an action, and one or more entities. Continuing with examples provided herein, an example response message can include “Added to Database: Brand X potato chips, snacks, price $12.99” (e.g., a response to an employee request for the inventory of “Brand X potato chips, $12.99, snacks category”). In some examples, the response message can include a request for clarification, and/or corrected information.

The system can visualize any of the configuration settings back to the user within the chat interface. For example, if a user configures a new product, the chat interface can display the product details for confirmation. The AI can also provide recommendations based on best practices or common configurations by using public AI models and training itself to constantly look for other practices and configurations and notifying the user of possible changes to the POS device 102 based on what the AI tool finds.

In any event, the chat interface, serves as the primary user interaction point, and the backend system handles chat interactions, integrates with the AI engine, and performs configuration actions.

Next, in some examples, the one or more data validation modules 242 validate information provided from the user through the channel(s). In some examples, a validation module 242 determines whether the information received is in an expected format. For example, the AI assistant may request an item number to be assigned to the item (e.g., a chat message stating “Please provide the item number”). A response message from the user is processed by the data validation module 242 to determine whether the response message includes the item number in the expected format (e.g., 6-digit number). For example, if the response message includes “ABC123,” the data validation module 242 can determine that the item number is not in the improper format. In such a case, a message can be provided back to the user indicating that the item number does not conform to the expected format (e.g., “this is an invalid format. Please provide the number in a 6-digit numerical format (######).”). As another example, if the response message includes “123456,” the data validation module 242 can determine that the item number is in the improper format. In such a case, the AI assistant can progress through the conversation (e.g., transition between contexts, as described in further detail herein).

In some implementations, the data validation module 242 determines whether a request is to be sent to one or more of the cloud-hosted services. Continuing with the above example, if the response message includes “123456,” the data validation module 242 can determine that the item number is in the improper format, and that there is no need to retrieve an intent or an entity from the cloud-hosted services.

In some implementations, components of the AI middleware 214 can be referred to as a conversation manager. Example components of the conversation manager can include the session manager 230, and the sensitive information masking component 232 of the AI middleware 214 of FIG. 2. Other components of the conversation manager can include a conversation logger, a domain integration component, and a conversation rule-base (not depicted in FIG. 2). In some examples, the conversation logger records all communications between the user and the AI assistant. In some examples, details of logged conversations can be used by the enterprise to monitor the effectiveness of the AI assistant in providing the intended user experience. In some examples, the domain integration component abstracts the details of integration with the back-end source systems 220 from the remainder of the AI assistant components. This includes abstraction of communication details, and data representations. In some examples, the conversation rules support an extended finite state machine approach to manage conversations with users, and to transition between different contexts based on multiple factors (e.g., intent, entities, actions). For example, responses to users are functions of context, intent, entities, and actions.

As mentioned above, the AI middleware (which is the same as the “AI engine” or “AI tool” referred herein) can perform configuration actions such as setting up payment methods, adding new products, configuring tax rates, business rules, receipt configuration, and managing user roles. The AI can also provide recommendations based on best practices or common configurations. This is all done through a chat interface, which serves as the primary user interaction point, and the backend system handles the chat interactions, integrates with the AI engine, and performs the above discussed (and other) configuration actions.

In some implementations, the cloud portion 204 includes one or more cloud-hosted services. Example cloud-hosted services include, without limitation, natural language processing (NLP) (e.g., entity extraction, intent extraction), sentiment analysis, speech-to-text, and translation. An example speech-to-text service includes Google Cloud Speech provided by Google, Inc. of Mountain View, Calif. In some examples, Google Cloud Speech converts audio data to text data by processing the audio data through neural network models. An example NLP service includes TensorFlow provided by Google, Inc. of Mountain View, Calif. In some examples, TensorFlow can be described as an open-source software library for numerical computation using data flow graphs. Although example cloud-hosted services are referenced herein, implementations of the present disclosure can be realized using any appropriate cloud-hosted service. As mentioned above, the AI engine may be powered by models or custom-trained NLP models that understand user prompts and generate appropriate responses. The AI engine is integrated with the chat interface to provide real-time guidance and responses so that when a user asks a question or requests a specific configuration, the AI tool interprets the query and provides step-by-step instructions or directly configures the system as needed and then presents an output.

In some implementations, the AI middleware 214 communicates with one or more of the back-end source systems 220 through the web service exposure 218. Example back-end source systems 220 include, without limitation, employee training systems, employee payment systems, inventory systems, a customer relationship management (CRM) system, a billing system, and an enterprise resource planning (ERP) systems. In some implementations, the AI middleware 214 communicates with the data management layer 222 to access the databases 224. In the depicted example, the data management layer 222 includes an (ETL) component, a data preparation component, a data transformation component, and a data extraction component.

The databases 224 (which may also include databases 116 from FIG. 1) include databases owned and operated by the company on premises 202, such as a product information database, a customer business rules database, an inventory database, a database of employees, equipment operations manuals and information database, database of sales data, customer database, company policies, procedures and/or rules database, operational procedures database, or any other database or collection of data that is used in managing and operating the POS device. The databases 224 may also include any information that is useful to an employee for assisting the employee in effectively, efficiently, and properly setting up the POS device. In this regard, the present disclosure is a means for the employee to have an AI-based system that automatically and quickly provide configuration and/or setup of the POS for the employee instead of the employee trying to do this complex task manually with all of the training required to know how to do this., all of which may be time consuming and complicated for the employee.

The databases 224 (e.g., MongoDB) may store any data, such as configuration settings for the POS device 102, user data, and interaction logs. The backend systems will provide the AI engine with appropriate context, and example to drive the AI engine. A prompt flow may be used to guide the result to a workable outcome.

Continuing with FIG. 2, the on-premise portion 202 also includes an administration component 250, a reporting and dashboards component 252, and a performance evaluation component 254.

In some implementations, the administration component 250 includes an intelligence service selector, an AI training component, and an AI model management component. In some examples, the intelligence service selector enables an administrator to select the cloud-hosted services to be used by the AI assistant (e.g., for NLP, sentiment analysis, translation). For example, selection may be the same for all capabilities, or the administrator may choose to select different cloud-hosted services for different capabilities (e.g., Cortana for NLP, Google ML for sentiment analysis). In some examples, the AI training component runs bulk training data against AI models of cloud-hosted services (e.g., AI model used for sentiment analysis), thereby allowing the administrator access to API features of the cloud-hosted service from a familiar front end. In some examples, the AI management component enables the administrator to maintain the intents and entities that are required to be processed by the cloud-hosted services, thereby allowing the administrator access to API features of the cloud-hosted service from a familiar front end.

In some implementations, the reporting and dashboards component 252 includes an audit log manager, an audit log repository, a reporting dashboard, and a conversation log repository. In some examples, the audit log manager enables the administrator to view all logs generated by the various AI assistant components (e.g., for operations monitoring and maintenance). In some examples, log messages are stored in the audit log repository. In some examples, the reporting dashboard enables the administrator to view all conversations that took place between the users and the AI assistant, and can indicate, for example, conversations that were completed successfully, and conversations that were abandoned.

In some implementations, the performance evaluation component 254 includes an AI accuracy reporting component, an AI testing facility, and an AI model log repository. In some examples, the AI accuracy reporting component measures the overall accuracy of the cloud-hosted services (e.g., based on deriving trained intents from inputs provided). In some examples, accuracy reports rely on the AI model log repository, in which each request and response made to the cloud-hosted services is logged. In some examples, the AI testing facility enables the administrator to interact directly with AI models of the cloud-hosted services to test respective performances of the AI model (e.g., in deriving the correct intent based on the user input).

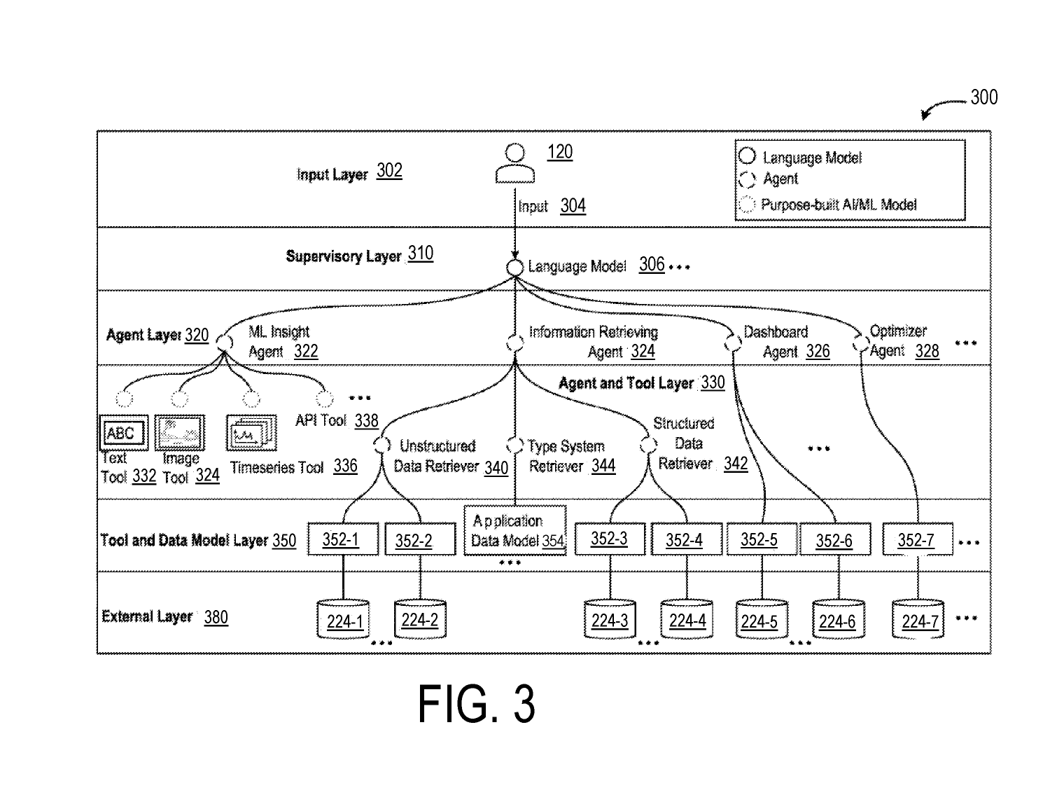

FIG. 3 depicts a diagram 300 of an example layered architecture and environment of the generative artificial intelligence system according to some embodiments. The enterprise generative artificial intelligence system architecture and environment includes a hierarchy of layers. More specifically, the hierarchy of layers includes an input layer 302, a supervisory layer 310, an agent layer 320, an agent and tool layer 330, a tool and data model layer 350, and an external layer 380. It will be appreciated that these layers are shown by way of example, and other examples can include any number of such layers (e.g., any number of layers 320 and 330).

The input layer 302 represents a layer of the enterprise generative artificial intelligence system architecture that receives an input (e.g., a query, complex input, instruction set, and/or the like) from a user or system of the retail store (e.g., an employee, store worker, authorized company representative, etc.). For example, an interface module of the enterprise generative artificial intelligence system may receive the input.

The supervisory layer 310 represents a layer of the enterprise generative artificial intelligence system architecture that includes one or more large language models (e.g., of an orchestrator module) that can develop a plan for responding to the input received in the input layer 302. A plan can include a set of prescribed tasks (e.g., retrieval tasks, API call tasks, and the like). In one example, the supervisory layer 310 can provide pre-processing and post-processing functionality described herein as well as the functionality of the orchestrators and comprehension modules described herein. The supervisory layer 310 can coordinate with one or more of the subsequent layers 320-380 to execute the prescribed set of tasks.

The agent layer 320 represents a layer of the enterprise generative artificial intelligence system architecture that includes agents that can execute the prescribed set of tasks. The agent layer 320 includes a machine learning insight agent 322, an information retrieving agent 324, a dashboard agent 326, and an optimizer agent 328. Each of the agents 324-328 can include a large language model (“LLM”) that provides reasoning functionality for accomplishing their assigned portion of the prescribed set of tasks. More specially, the agents 324-328 can instruct the agents and tools of subsequent layers (e.g., layer 330), of which there could be any number, to execute the tasks. For example, the machine learning insight agent 322 can instruct the text processing tool 332 to perform a text processing task (e.g., transform an artificial intelligence application output into natural language), an image processing tool 334 to perform an image processing task (e.g., generate a natural language summary of an image outputted from artificial intelligence application), a timeseries tool 336 to obtain summarize timeseries data (e.g., timeseries data output from an artificial intelligence application), and an API tool 338 to perform an API call task (e.g., execute an API call to trigger or access an artificial intelligence application). Other tasks as explained above, could be tools for configuring the POS: setting up product information, prices, etc. for the POS, configuring procedures and rules for the POS, allowing for training of the POS, or any other data that is used in configuring and running the POS device 102.

The information retrieving agent 324 may cooperate with, and/or coordinate, several different agents to perform data retrieval tasks. For example, the information retrieving agent 324 may instruct an unstructured data retriever agent 340 to receive unstructured data records, a structured data retriever agent 342 to retrieve structured data records, and a type system retriever agent 344 to obtain one or more data models (or subsets of data models) and/or types from a type system. The type system provides compatibility across different data formats, protocols, operating languages, disparate systems, etc. Types can encapsulate data formats for some or all of the different types or modalities described herein (e.g., multimodal, text, coded, language, statistical, audio, visual, audiovisual, etc.). For example, a data model may include a variety of different types (e.g., in a tree or graph structure), and each of the types may describe data fields, operations, functions, and the like. Each type can represent a different object (e.g., a real-world object) or system (e.g., computing cluster, enterprise databases, file systems, etc.), and each type can include a large language model context that provides context for the large language model to design or update a plan. For example, the context may include a natural language summary or description of the type (e.g., a description of the represented object, relationships with other types or objects, associated methods and functions, and the like). Types can be defined in a natural language format for efficient processing by large language models. The type system retriever agent 344 may traverse the data model 354 to retrieve a subset of the data model 354 and/or types of the data model 354. The structured data retriever agent 342 can then use that retrieved information to efficiently retrieve structured data from a structured data source (e.g., a structured data source that is structured or modeled according to the data model 354).

The dashboard agent 326 may be configured to generate one or more visualizations and/or graphical user interfaces, such as dashboards. For example, the dashboard agent 326 may execute tools 352-5 and 352-6 to generate dashboards based on information retrieved by the other agents and/or information output by the other agents (e.g., natural language summaries of associated tool outputs).

The optimizer agent 328 may be configured to execute a variety of different prescriptive analytics functions and mathematical optimizations 352-7 to assist in the calculation of answers for various problems. For example, the large language model 306 may use the optimizer agent 328 to generate plans, determine a set of prescribed tasks, determine whether more information is needed to generate a final result, and the like.

The tool and data model layer 350 is intended to represent a layer of the enterprise generative artificial intelligence system architecture that includes tools 352 and the data model 354. The agents 340-342 can execute the tools 352 to retrieve information from various applications and databases 224 in the external layer 380 (e.g., external relative to the enterprise generative artificial intelligence system). The tools 252 may include connectors that can connect to systems and datastore that are external to the enterprise generative artificial intelligence system.

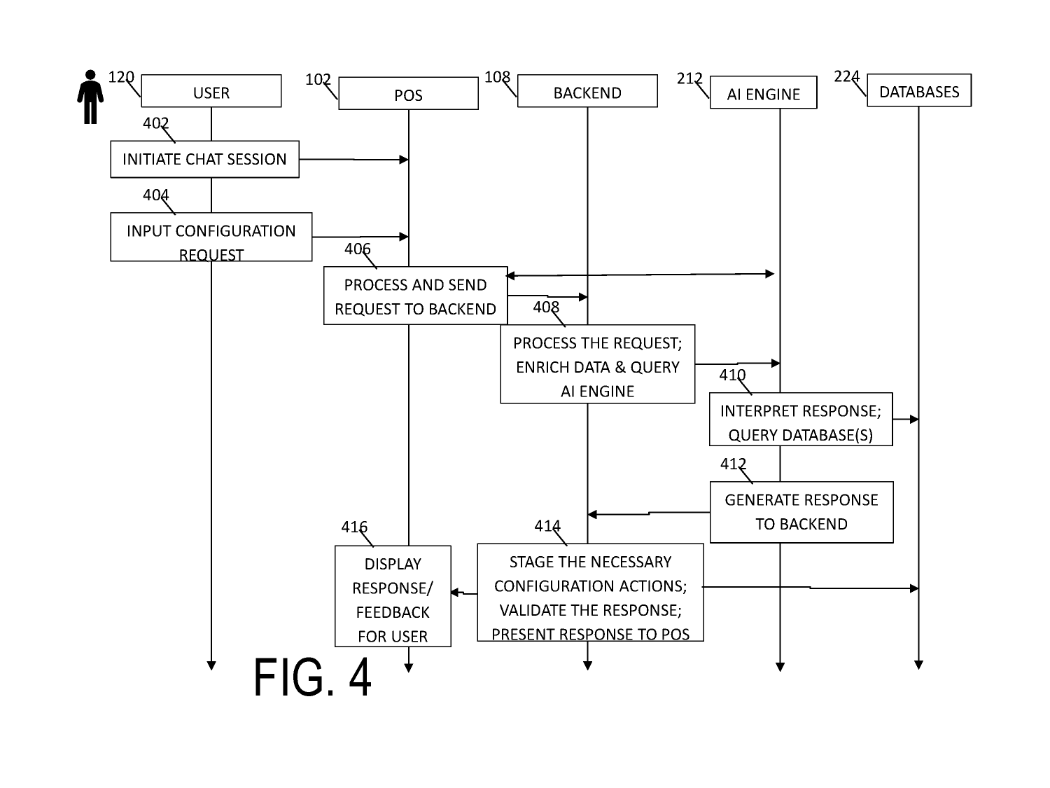

FIG. 4 depicts an example of process 400 that can be executed in implementations of the present disclosure. In some examples, the example process 400 is provided using one or more computer-executable programs executed by one or more computing devices (e.g., the back-end system 108 of FIG. 1).

In block 402, a user 120 initiates a chat session with the POS device 102. The user 120 will need to authenticate himself to the POS device 102 such as by logging in so that only authorized users can configure and set up the POS device 102.

In block 404, the user 120 inputs a configuration request to the POS device 102 via a chat interface of the POS device 102. In block 406, the request is processed and sent to the backend server 108. In this regard, the POS device 102 will communicate with the AI engine 212 which will assist in identifying that the user 120 has provided as request, which at that point, the POS device 102 will then trigger sending the request to the backend server 108.

In block 408, the backend server 108 processes the request, enriches the data, and queries the AI engine 212. In this regard, the request is parsed to determine the action requested, the data provided, and the like. The backend server 108 will then determine what additional data is needed based on reformatting of the request by the AI engine 212.

In block 410, the AI engine 212 interprets the request and generates a response to the backend server 108. The AI engine 212 determines what the request is directed to, determines a series of data needed to fulfil this request, and then compares the data provided with the data needed. The response back from the AI engine 212 will include any requests back to the user for more information where there are data sets that are either missing, in an incorrect format or if the data is not understood, the AI engine 212 will provide that information to the user 120 visually via a chat interface of the POS device 102.

In block 410, the AI engine 212 also may query the database 224 for any information needed. Moreover, if all data is provided and the AI engine 212 has what is needed, the AI engine 212 will inform the backend of the instructions that the backend server 108 should take.

In block 412, the response (including the instructions for the backend server 108) is sent back to the backend server 108 so that the backend server 108 stages the necessary configuration actions, validates the response, and presents such results back to the user 120. In this regard, the backend server 108 will then execute the instructions provided by the AI engine 212 to the backend server 108. For example, the backend server 108 can update databases 224, update software in the POS device 102, change rules/procedures in the POS device 102 or in the databases 224 or cloud services, etc.

In block 414, the chat interface displays the response or any other visual feedback to the user 120.

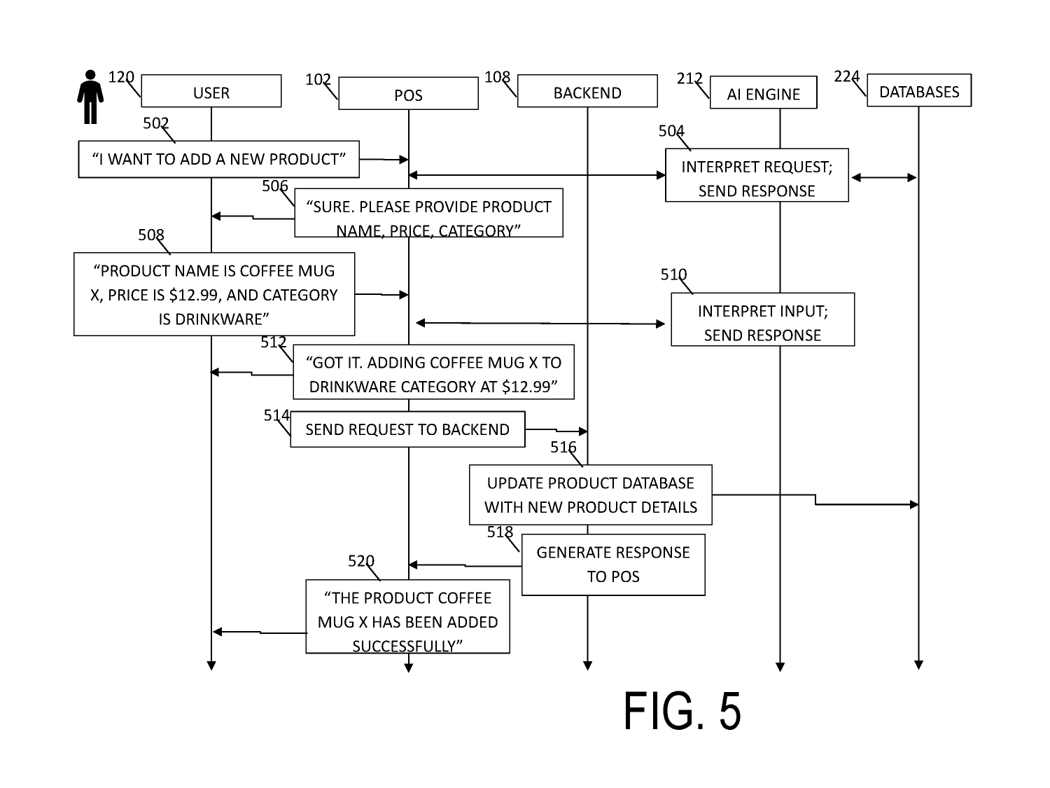

FIG. 5 depicts an example process that can be executed in accordance with implementations of the present disclosure. In FIG. 5, a specific example process based on FIG. 4 is provided. In this example, an employee that has been authenticated to the POS device 102.

First, in block 502, the user talks toward the POS device 102 to state "I want to add a new product." The POS device 102 receives the speech, converts the speech to text and then transmits the text request to the AI engine 212 via the chat interface of the POS device 102.

In block 504, the AI engine 212 interprets the request from the user using LLM as the user wanting to update the product database 224. The AI engine 212 determines what data is needed (product name, price, and category) based on looking at the product database 224 and responds "Sure, please provide the product name, price, and category", using the procedures discussed above with regard to FIGS. 1-3.

Then, in block 508, the user states to the POS device 102 "product name is 'Coffee Mug', price is $12.99, and category is 'Drinkware'."

In block 510, a similar process to 504 occurs but the AI engine 212 determines if all data requested has been provided and formats the data as needed based on the steps and systems discussed in FIGS. 1-3. The AI engine 212 determines the data is complete and responds: "Got it. Adding 'Coffee Mug' to 'Drinkware' category with a price of $12.99" as shown in block 512. The AI engine 212 also sends instructions to the backend server 108 to update the product database 224, using the procedures discussed above with regard to FIGS. 1-3.

In block 514, the backend server 108 updates the product database with the new product details based on the instructions from the AI engine.

In block 516, visual feedback is provided to the user via the POS device 102 as follows "The product 'Coffee Mug' has been added successfully." In this regard, the system can visualize the configuration settings back to the user within the chat interface. For example, if a user configures a new product, the chat interface can display the product details for confirmation.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof, means any connection or coupling, either direct or indirect, between two or more elements; the coupling of connection between the elements can be physical, logical, or a combination thereof. Additionally, the words "herein," "above," "below," and words of similar import, when used in this application, shall refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The above detailed description of embodiments of the present disclosure is not intended to be exhaustive or to limit the present disclosure to the precise form disclosed above. While specific embodiments of, and examples for, the present disclosure are described above for illustrative purposes, various equivalent modifications are possible within the scope of the present disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the present disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the present disclosure can be modified, if necessary, to employ the systems, functions, and concepts of the various references described above to provide yet further embodiments of the present disclosure.

These and other changes can be made to the present disclosure in light of the above Detailed Description. While the above description describes certain embodiments of the present disclosure, and describes the best mode contemplated, no matter how detailed the above appears in text, the present disclosure can be practiced in many ways. Details of the system may vary considerably in its implementation details, while still being encompassed by the present disclosure disclosed herein. As noted above, particular terminology used when describing certain features or aspects of the present disclosure should not be taken to imply that the terminology is being redefined herein to be restricted to any specific characteristics, features, or aspects of the present disclosure with which that terminology is associated. In general, the terms used in the following claims should not be construed to limit the present disclosure to the specific embodiments disclosed in the specification, unless the above Detailed Description section explicitly defines such terms. Accordingly, the actual scope of the present disclosure encompasses not only the disclosed embodiments, but also all equivalent ways of practicing or implementing the present disclosure under the claims.

While certain aspects of the present disclosure are presented below in certain claim forms, the inventors contemplate the various aspects of the present disclosure in any number of claim forms. For example, while only one aspect of the present disclosure may be recited as a means-plus-function claim under 35 U.S.C sec. 112(f), other aspects may likewise be embodied as a means-plus-function claim, or in other forms, such as being embodied in a computer-readable medium. (Any claims intended to be treated under 35 U.S.C.§112(f) will begin with the words "means for".) Accordingly, the inventors reserve the right to add additional claims after filing the application to pursue such additional claim forms for other aspects of the present disclosure.

What is claimed is:

1. A method for a company employee to use an artificial intelligence (AI) engine for helping the employee in connection with the employee’s employment with the company, the method comprising:
receiving, by a processor of a generative AI-based system, a voice or text request from the employee via a chat interface of a point of sale (POS) device to configure the POS device;
determining, by the processor of the generative AI-based system, at least one action that is to be performed for configuring or setting up the POS device by at least one back-end source system of the company using data determined in the request;
generating, by the processor of the generative AI-based system, a response for the at least one back-end source system to perform in configuring the POS device; and
transmitting, by the processor of the generative AI-based system, the response to the at least one back-end source system so that the at least one back-end source system directly configures the POS device.

2. The method according to claim 1, further comprising:
determining that a data set to be transmitted in the response comprises sensitive information, and in response to determining sensitive information being transmitted over a network, masking the sensitive information in the data set using an on-premise masking component prior to transmitting the response.

3. The method according to claim 1, wherein the request is for configuring one of the following: POS device itself, product information, inventory, company policies, and operational procedures.

4. The method of claim 1, wherein the request is from an employee for the generative AI-based system to provide configuration and setup of the POS device prior to the POS device being operational at the company.

5. The method of claim 4, further comprising providing the AI engine training data for training the AI engine on configuring and setting up systems for and around the POS device.

6. The method according to claim 1, wherein the generative AI-based system comprises an intent classification model using natural language processing (NLP) to provide an intent set comprising one or more intents indicated in the request.

7. The method according to claim 1, wherein the actions for configuring the POS device comprises setting up payment methods, adding new products, configuring tax rates, business rules, receipt configuration, and managing user roles.

8. A generative AI-based system comprising:
a processor configured for:
receiving, by a processor of a generative AI-based system, a voice or text request from the employee via a point of sale device to configure the POS device;
determining, by the AI engine, at least one action that is to be performed for configuring the POS device by at least one back-end source system of the company using data contained in the request;
generating, by the AI engine, a response for the at least one back-end source system to perform in configuring the POS device; and
transmitting, by the processor, the response to the at least one back-end source system so that the at least one back-end source system configures the POS device.

9. The system according to claim 8, wherein the processor is further configured for:
determining that a data set to be transmitted in the response comprises sensitive information, and in response to determining sensitive information being transmitted over a network, masking the sensitive information in the data set using an on-premise masking component prior to transmitting the response.

10. The system according to claim 8, wherein the actions for configuring the POS device comprises setting up payment methods, adding new products, configuring tax rates, business rules, receipt configuration, and managing user roles.

11. The system according to claim 8, wherein the request is from an employee for the generative AI-based system to provide configuration and setup of the POS device prior to the POS device being operational at the company.

12. The system according to claim 8, further comprising providing the AI engine training data for training the AI engine on configuring and setting up systems for and around the POS device.

13. The system according to claim 8, wherein the generative AI-based system comprises an intent classification model using natural language processing (NLP) to provide an intent set comprising one or more intents indicated in the request.

14. The system according to claim 8, wherein the POS device comprises a self checkout system configured customers to self scan and identify products as well as pay for the products.

15. The system according to claim 8, wherein the request is from an employee that is authenticated to the system as an administrator.

16. A nontransitory computer readable medium that, when executed by a processor of a generative AI-based system, performs a method comprising:
receiving, by a processor of a generative AI-based system, a voice or text request from the employee via a point of sale device to configure the POS device;
determining, by the AI engine, at least one action that is to be performed for configuring the POS device by at least one back-end source system of the company using data contained in the request;
generating, by the AI engine, a response for the at least one back-end source system to perform in configuring the POS device; and
transmitting, by the processor, the response to the at least one back-end source system so that the at least one back-end source system configures the POS device.

17. The nontransitory computer readable medium according to claim 16, wherein the method further comprising:
determining that a data set to be transmitted in the response comprises sensitive information, and in response to determining sensitive information being transmitted over a network, masking the sensitive information in the data set using an on-premise masking component prior to transmitting the response.

18. The nontransitory computer readable medium according to claim 16, wherein the request is from an employee for the generative AI-based system to provide configuration and setup of the POS device prior to the POS device being operational at the company.

19. The nontransitory computer readable medium according to claim 16, further comprising providing the AI engine training data for training the AI engine on configuring and setting up systems for and around the POS device.

20. The nontransitory computer readable medium according to claim 19, wherein the actions for configuring the POS device comprises setting up payment methods, adding new products, configuring tax rates, business rules, receipt configuration, and managing user roles.
